(19) United States
(12) Patent Application Publication
(10) Pub. No.: US 2015/0116691 A1
(43) Pub. Date: Apr. 30, 2015

(54) INDOOR SURVEYING APPARATUS AND METHOD

(71) Applicant: Alexander Likholyot, Kitchener (CA)

(72) Inventor: Alexander Likholyot, Kitchener (CA)

(73) Assignee: PLANITAR INC., Kitchener (CA)

(21) Appl. No.: 14/064,096

(22) Filed: Oct. 25, 2013

(51) Int. Cl. G01S 17/89; G01S 17/42; G01C 15/00

(52) U.S. Cl. CPC G01S 17/89; G01C 15/002; G01S 17/42
USPC 356/4.01

(57) ABSTRACT

An indoor surveying apparatus comprises a light source, a color imaging system, a memory storing calibration coefficients, and a computing device for determining coordinates of 3D intersection points of the emitted light with objects using calibration coefficients and images captured by the imaging system. A method of using the surveying apparatus comprises the steps of capturing first image of a scene illuminated by the light source, capturing second image of the scene without the illumination by the light source, comparing the two images to identify locations of the 3D intersection points in the first image, using the set of calibration coefficients and the locations of the 3D intersection points in the first image to compute 3D coordinates of the intersection points, whereby surveying information collected by the apparatus comprises the coordinates of 3D intersection points and the color photographic images captured from known poses relative to the 3D intersection points.

### BACKGROUND OF THE INVENTION

The field of the present invention is surveying apparatuses for measuring layout of buildings and capturing photographic data. A surveying apparatus necessarily performs a geometric instrument function and, depending on the underlying technology, can perform a photographic function and an optical measuring function as in the field of optical metrology.

Currently, buildings are surveyed most of the time using simple measuring tools, such as a mechanical tape measure or a laser “tape measure”—a laser distance meter. U.S. Pat. No. 7,460,214 and U.S. patent application Ser. No. 10/724,259 describe systems that add angle measuring capabilities to laser distance meters to increase speed and efficiency with which the measurements can be done. Nevertheless, a workflow using such tools is very slow and a surveyor needs to spend a considerable amount of time on-site taking measurements.

It would be advantageous to be able to capture surveying data on-site quickly and to allow post-processing and analysis of data and creation of floor plans to be carried out elsewhere. In addition, it would be advantageous to capture image data for the purpose of documenting a site in a fashion that would allow the image data to be correlated with floor plans, for example, by recording an accurate location and direction from which each image was taken. Such instruments and a combination of measurement and image data can find uses in several industries. As an example, in a real estate industry or in an insurance industry such an indoor surveying apparatus can be used for capturing floor plans and images of a property that can be subsequently displayed in a virtual tour. As a further example, in forensic sciences such an indoor surveying apparatus can be used for documenting a crime scene and can provide a capability to make subsequent measurements using captured floor plan and image data. As yet another example, in a construction industry such an indoor surveying apparatus can be used to capture structural elements of a building at various construction stages, such as capturing a house frame with embedded wiring before drywall gets installed and wiring gets covered.

Currently, the only commercially available technology for capturing correlated dimensioned layout and image data is a 3D laser scanner that may include a camera for capturing image or texture data that can be overlaid on a 3D point cloud. Several manufacturers offer such instruments that have high accuracy and long range, which makes them suitable for both indoor and outdoor applications requiring high resolution. The software provided with the 3D laser scanners typically allows extracting 2D slices from 3D point cloud that can be used for drawing floor plans. While such instruments are versatile, the amount of data they capture is excessive for the usage scenarios listed above, the time required to capture a 3D scan of a room is still on the order of few minutes, and the cost of such instruments is prohibitively expensive for the mentioned uses.

Therefore, there remains a considerable need for an indoor surveying apparatus and method that can allow measuring 2D layout and capturing high quality images correlated with the measurement data, performing these tasks quickly, allowing off-line processing and analysis of data, while being easy to use, and having reasonable cost.

### BRIEF SUMMARY OF THE INVENTION

The present invention is directed to an indoor surveying apparatus for surveying an interior of a building, the apparatus having a light source emitting a divergent light beam with specific divergence parameters and wavelength, an optical imaging system for capturing color photographic images of its environment and 3D intersection points of the light beam with objects, a set of calibration coefficients modeling the apparatus, and a computing device for computing 3D coordinates of the 3D intersection points of the light beam with objects, whereby surveying information collected by the apparatus comprises the coordinates of the 3D intersection points and the color photographic images captured from known poses relative to the 3D intersection points.

Among the many different possibilities contemplated, the surveying apparatus can further comprise a computing device executing an algorithm for establishing positions and extents of walls, doors, and windows and for drawing floor plans using the 3D coordinates of the 3D intersection points and the images captured by the imaging system, wherein the images can be used for establishing positions and extents of walls, doors, and windows where the 3D intersection points are missing. It is further contemplated that the light source of the surveying apparatus can advantageously comprise a laser with line-generating optics. It is still further contemplated that the imaging system of the surveying apparatus can advantageously be a consumer digital camera. It is yet further contemplated that the lens of the imaging system can advantageously be a wide-angle lens with at least 90 degree, at least 120 degree, or at least 180 degree field of view. It is still further contemplated that an indoor surveying apparatus can advantageously include an electronic compass. It is yet further contemplated that the indoor surveying apparatus can advantageously include a stand and a rotator that enables the surveying apparatus to be repeatably rotated into two, three, or four predetermined angular positions relative to the stand. It is still further contemplated that the rotator can include an encoding means for identifying the individual angular positions.

The present invention is also directed to a method of using the indoor surveying apparatus for surveying an interior of a building, comprising the steps of capturing first image of a scene illuminated by the light source and the 3D intersection points of the light beam with objects, capturing second image of the scene without the illumination by the light source, comparing the two images to identify locations of the 3D intersection points in the first image, using the set of calibration coefficients and the locations of the 3D intersection points in the first image to compute 3D coordinates of the 3D intersection points.

It is further contemplated that the method of using the surveying apparatus can advantageously comprise projecting the 3D intersection points onto a horizontal plane to obtain projected 2D point data set describing the outlines of the building's walls and other indoor objects, using the projected 2D point data set for establishing positions and extents of walls, doors, and windows and for drawing floor plans for the building, and using the set of calibration coefficients and the images captured by the imaging system for establishing positions and extents of walls, doors, and windows and for drawing floor plans where the projected 2D points are missing. It is yet further contemplated that the method of using the surveying apparatus can further comprise providing a stand and a rotator, rotating the apparatus into first angular position, performing the steps according to the method of using the surveying apparatus as described previously, rotating the apparatus into second angular position having a predetermined angular offset relative to the first angular position, performing the steps according to the method of using the surveying apparatus as described previously, and using the predetermined angular offset between the first and the second angular positions to combine the projected 2D points obtained at the first and at the second angular positions into a combined projected 2D point data set, whereby the combined projected 2D point data set provides greater spatial coverage than the first and the second projected 2D point data sets individually. It is still further contemplated that the method of using the surveying apparatus can further comprise placing the surveying apparatus at first location in the building and obtaining first combined projected 2D point data set, placing the surveying apparatus at second location having common surfaces with the first location, which are visible from both the first and the second locations and obtaining second combined projected 2D point data set, and aligning the first and the second combined projected 2D point data sets in 2D space by aligning 2D points that belong to the common surfaces between the first and the second locations.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING

FIG. 1 is a conceptual diagram of an indoor surveying apparatus in its environment according to one embodiment of the invention. Not all of the elements shown in FIG. 1 may be present in other possible embodiments. The elements are shown in FIG. 1 to illustrate their functional relationship to each other when they are present in an embodiment.

FIG. 2 schematically shows input and output of the 2D point data set alignment process, which brings the 2D point data sets into a common coordinate system and produces a map of indoor environment.

FIG. 3 is a schematic view of a user interface displayed by a computing device executing an algorithm for establishing positions and extents of walls, doors, and windows and for drawing floor plans according to one embodiment of the invention. FIG. 3 is intended to illustrate how images that are correlated with 2D point data sets can be used for establishing positions and extents of walls, doors, and windows and drawing floor plans where the 2D points are missing.

### DETAILED DESCRIPTION OF THE INVENTION

Features and advantages of the present invention will be better understood by reading the following detailed description, taken together with the drawing.

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims. Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise.

Unless the meaning is clearly to the contrary, all ranges set forth herein are deemed to be inclusive of the endpoints.

Unless specified otherwise, the term “substantially”, when used with angles or angular orientation, describes possible deviations within 5 degrees.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

An indoor surveying apparatus according to the present invention includes several elements that inter-operate. Each of the elements, including some of their possible variants, will be defined and described in the following discussion. It has to be understood that various embodiments of an indoor surveying apparatus according to the present invention can include any suitable combination of possible variants of the constituting elements.

To give a concise and conceptual overview of an indoor surveying apparatus and illustrate a method of its use, one preferred embodiment will be described in the beginning briefly with a more detailed description of contemplated elements and examples of other contemplated embodiments to follow. In the most preferred embodiment, an indoor surveying apparatus comprises a consumer DSLR or mirrorless camera with a panoramic wide-angle fisheye lens with at least 180 degree field of view angle, both the camera and the lens mounted on a bracket with a lens clamp and coupled to a panoramic rotator, which is, in turn, mounted on a photographic tripod or other suitable stand. Such an arrangement is common in the field of panoramic photography and is well known to those skilled in the art, panoramic bracket and rotator kits being available commercially. Further, two lasers with line-generating optics, for example, Powell lenses or diffractive line-generating elements, each with a fan angle of approximately 90 degrees, are coupled to the camera and are located above the camera at a distance of approximately 20 centimeters from the camera. The lasers are each oriented such as to project a horizontal line on the walls of a room, the line being located at a height above the floor that is the same as the height of the lasers above the floor or, equivalently, with the laser beams propagating substantially horizontally, and the two lines produced by the two lasers desirably having no overlap, such as to have the total fan angle of the combined laser beams span approximately 180 degrees to match the field of view angle of the wide-angle lens. The projected lines can be described to consist of 3D illuminated points and to have a finite line width. The lasers are advantageously focussed such as to produce light beams with divergence in the vertical direction between 2 milliradians and 8 milliradians. Relative position of the camera and the lasers and optical geometry and properties of the camera and geometry of the light beams can be calibrated and described by a mathematical model and a set of calibration coefficients. By identifying position of the laser lines in images captured by the camera and using the calibration coefficients, 3D positions of the 3D illuminated points can be computed and then the 3D illuminated points in space can be projected onto a horizontal plane, for example, onto the floor, yielding a 2D outline of the walls consisting of 2D points with known coordinates spanning the sector of approximately 180 degrees. By rotating the apparatus on a panoramic rotator two times, by substantially 120 degrees each time and starting from a current angular position, and capturing images at each angular position, a complete 360 degree 2D outline of a room can be measured. The overlapping fisheye images can be stitched into a 360 by 180 degree spherical panorama allowing observation of surrounding space both all the way around and up or down. Panoramic image stitching is well known to those skilled in the art. By repeating this procedure for every room on a floor and aligning rooms using common 2D points, a complete floor plan accompanied by panoramas can be generated, wherein for each panorama location of the vantage point from which it was captured is precisely known and can be indicated on the floor plan. It has to be understood that the described embodiment of the surveying apparatus is one of many other embodiments contemplated.

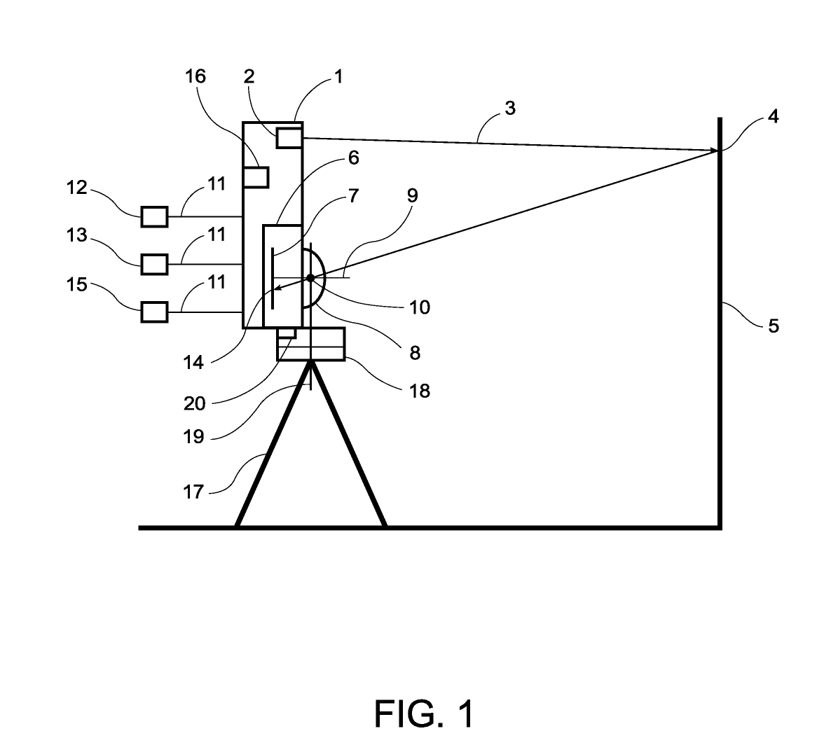

In general and as shown in FIG. 1, in a preferred embodiment an indoor surveying apparatus has a body frame 1 that houses light source 2 and optical imaging system 6, both the light source and the imaging system being rigidly coupled to the body frame. The light source 2 and the optical imaging system 6 are preferably in a vertical relation, with the light source 2 being positioned either below or, more preferably, above the optical imaging system 6. Any appropriate distance between the light source 2 and the optical imaging system 6 can be chosen, preferably between 5 centimeters and 65 centimeters, and more preferably approximately 20 centimeters. The imaging system 6 comprises a color image sensor 7 and objective lens 8. The objective lens 8 has optic axis 9 and entrance pupil 10. The lens is preferably oriented such as to have the optic axis form at most a 30 degree angle with a horizontal plane, more preferably being substantially parallel to a horizontal plane.

The light source 2 projects a light beam 3 towards wall 5 and the light beam intersects the wall at a plurality of 3D intersection points 4 that are illuminated by the light beam. The 3D intersection points 4 are imaged by the imaging system 6 onto the image sensor 7 at a plurality of locations 14. The light source 2 is configured to have the light beam 3 propagating in directions that form at most 15 degree angles with a horizontal plane, more preferably being substantially parallel to a horizontal plane. The wavelength of the light emitted by the light source 2 is preferably between 350 nanometers and 1000 nanometers, and more preferably between 450 nanometers and 690 nanometers. The light beam 3 is preferably divergent in a horizontal direction with divergence of at least 50 milliradians and more preferably with divergence of at least 1.5 radians. The number of light beams emitted by the light source 2 and their divergence in a horizontal direction are preferably chosen such as to have the combined divergence angle of all the light beams in a horizontal plane substantially equal to or greater than the field of view angle of the objective lens 8, so that images of the plurality of 3D intersection points 4 at the locations 14 extend across a full image captured by the imaging system 6. Any suitable light source can be used, for example a light source comprising light emitting diodes or laser diodes and comprising suitable beam-shaping optics. In a preferred embodiment the light source comprises at least one laser with line-generating optics, for example a Powell lens or a line-generating diffractive element.

In order to identify locations 14 in the images captured by the imaging system 6, a technique known as background subtraction is preferably used. According to that technique, first image of a scene is captured with the light source 2 turned on using appropriate exposure time. Then second image is captured using the same exposure time, but with the light source 2 turned off. This order of image taking can be reversed. The two images are then compared in order to extract images of the illuminated 3D intersection points 4 and identify locations 14, preferably by subtracting the second image from the first image. The second image, being a color image, can subsequently be advantageously used for photographically documenting the environment.

After background subtraction, the resulting image containing locations 14 is split into vertical stripes corresponding to pixel columns of the image sensor 7. The vertical stripes contain pixel light intensities resulting predominantly from illumination by the light source 2. Each stripe or column has an assigned horizontal position with 1 pixel resolution corresponding to the pixel column number. Ordinarily, the light beam 3 would be focussed such as to minimize the beam divergence in the vertical direction, which would lead to maximizing pixel intensity at locations 14. For example, this is the case for most laser scanners. However, in an indoor surveying apparatus described in this disclosure the light beam 3 is purposefully defocussed in the vertical direction to have vertical divergence preferably between 1 milliradian and 20 milliradians, and more preferably between 2 milliradians and 8 milliradians. Such defocusing allows images of the illuminated 3D intersection points 4 to always span several pixels in the vertical direction within the vertical stripes or columns of the image sensor 7 at locations 14, irrespective of the distance of the 3D intersection points 4 from the light source. Spanning several pixels then allows locations 14 to be digitized with sub-pixel resolution in the vertical direction of the image sensor 7 using any of the suitable methods known in the art, preferably using a centroid or center of mass method. This approach results in a greatly improved measurement accuracy, enabling an indoor surveying apparatus according to this disclosure to meet the BOMA Standard requirements for floor plan accuracy.

In FIG. 1, digitized locations 14 form a 2D point data set in the plane of the image sensor 7. In order to calculate 3D coordinates of the illuminated 3D intersection points 4 from coordinates of the locations 14, the 2D points at the locations 14 are preferably first corrected for lens distortion, then for each of the 2D points a ray originating at that point in the plane of the image sensor 7 is back-projected through the objective lens 8 outside the imaging system 6 and intersected with the light beam 3, thus obtaining 3D coordinates of the 3D intersection points 4 by triangulation. Lens distortion correction, ray back-projection, and triangulation are standard steps well known to those skilled in the art. A computing device 13 having a wired or wireless connection 11 to the surveying apparatus executes an algorithm for computing 3D coordinates of the 3D intersection points 4, preferably a triangulation algorithm as cited above. In a preferred embodiment the computing device 13 is a portable computing device, for example, a tablet or a netbook. In other contemplated embodiments the computing device 13 can be an embedded computing device coupled to the body frame 1.

Distortion model and calibration coefficients describing focal length and distortion of the objective lens 8, position and orientation of the image sensor 7 relative to the objective lens 8 can be obtained according to any of the numerous known in the art methods of camera calibration. See, for a preferred implementation, Z. Zhang “A flexible new technique for camera calibration” in IEEE Transactions on Pattern Analysis and Machine Intelligence (2000), where a flat calibration object with a pattern of known geometry is photographed by a camera from different poses and the calibration object's position and orientation for each pose are fitted together with the camera's calibration coefficients. This publication and all other referenced publications are incorporated herein by reference in their entirety. Furthermore, where a definition or use of a term in a reference, which is incorporated by reference herein is inconsistent or contrary to the definition of that term provided herein, the definition of that term provided herein applies and the definition of that term in the reference does not apply.

Additional calibration coefficients are needed to compute coordinates of 3D intersection points 4. They describe position and orientation of the imaging system 6 relative to the light beam 3 and the light beam geometry. These calibration coefficients can be obtained, preferably, in the following way. After performing a first calibration step according to the cited method by Z. Zhang, the flat calibration object that was used during the first step is photographed by the imaging system 6 at several poses such that the light beam 3 intersects the flat calibration object at at least two different distances from the light source 2. Next, position and orientation of the calibration object in 3D space for each pose is computed by a non-linear least squares method in a way analogous to how it was done in the first step to yield position and orientation of the front plane of the flat calibration object relative to the imaging system 6. Back-projection of rays originating at the locations 14 to intersect with all such front planes yields 3D coordinates of the 3D intersection points relative to the imaging system 6. These 3D intersection points then completely describe position and orientation of the imaging system 6 relative to the light beam 3 and the light beam geometry. In a preferred embodiment comprising a laser with line-generating optics, the light beam geometry is a plane and position and orientation of the imaging system 6 relative to that plane is trivially computed from the 3D intersection points. It has to be understood, that other light beam geometries are contemplated, for example piecewise planar geometries producing piecewise linear projections on the walls, which geometries can, for example, be realized by using multiple lasers with line-generating optics or one laser with a suitable diffractive optics. In another contemplated embodiment, the laser source 2 can comprise a laser with a spinning mirror, such as to produce a laser beam spinning around a substantially vertical axis.

As shown in FIG. 1, the calibration coefficients can be stored in memory 12 having a wired or wireless connection 11 to the surveying apparatus and the computing device 13. In a preferred embodiment memory 12 can be part of the computing device 13.

During surveying of a building, the majority of surfaces being measured are vertical surfaces of walls. Measured 3D intersection points 4 located on the vertical walls can be projected onto a horizontal plane to yield a projected 2D point data set to support drawing of floor plans. This projection requires knowing tilt of the body frame 1 relative to the direction of gravity. Tilt of the body frame 1 can be set to a fixed value, preferably zero tilt, by any suitable means, for example using a bubble level coupled to the body frame 1. Alternatively, tilt of the body frame 1 can be measured by any suitable means, for example using a 2-axis or 3-axis accelerometer. If tilt of the body frame 1 is controlled or measured, then the 3D intersection points 4 can be easily projected onto a horizontal plane. If tilt of the body frame 1 is neither controlled nor measured, then the 3D intersection points 4 can still can be projected onto a horizontal plane to yield a 2D point data set using an assumed tilt, the accuracy of the resulting survey data being lower as a result.

In a preferred embodiment the objective lens 8 is a wide-angle lens, preferably with a field of view angle of at least 90 degrees, more preferably at least 120 degrees, and even more preferably at least 180 degrees, however, other field of view angles are also contemplated. A choice of the lens can depend on a desired balance between a field of view angle for a single capture and image resolution needed to provide high quality photographic images to be used for visually describing the environment as part of the surveying process. Such a choice is a trade-off well known to those skilled in the art. A wide-angle lens, especially for larger field of view angles, can preferably benefit from an improved lens model better describing fisheye lenses, see F. A van den Heuvel, R. Verwaal, B. Beers “Calibration of fisheye camera systems and the reduction of chromatic aberration” in Proceedings ISPRS Commission V Symposium, IAPRS Vol. XXXVI, Part 5 (2006). If field of view angle of the objective lens 8 is smaller than 180 degrees, it may be preferable to have the optic axis 9 form a non-zero angle with a horizontal plane in an upward direction in order to increase photographic coverage of space above the camera, for example to capture more of a room's ceiling.

A field of view angle of the objective lens 8 limits measured 3D intersection points 4 and their 2D projections on a horizontal plane to a planar sector with the apex angle equal to the field of view angle of the objective lens. In order to survey a whole space around the surveying apparatus, a 360 degree coverage is needed and the surveying apparatus necessarily must be rotated to capture images at additional angular positions. In a preferred embodiment a surveying apparatus according to this disclosure comprises a stand 17, preferably a photographic tripod, and a rotator 18, wherein the apparatus is coupled to the rotator and the rotator is coupled to the stand. As shown in FIG. 1, the rotator has its rotation axis 19 aligned to be preferably vertical and has its rotation axis 19 positioned such as to pass preferably through the entrance pupil 10 of the objective lens 8. The rotator preferably enables the apparatus to be repeatably rotated relative to the stand through a number of predetermined substantially equally spaced angular positions, wherein the images captured at different angular positions can be advantageously stitched into a panorama, as is often done in the field of panoramic photography, and the 2D point data sets measured at each angular position can be advantageously merged into a combined 2D point data set using known angular spacing between the angular positions. Rotation of the imaging system around the entrance pupil 10 of the objective lens 8 reduces parallax errors when stitching images into a panorama. Repeatability of the angular positions can be achieved, for example, by rotator having detents and a ball plunger that engages them, as is often done in commercially available panoramic rotators. The number of used angular positions and their angular spacing can depend on the field of view angle of the objective lens 8 and desired image overlap for the purposes of obtaining high quality panoramas. In a preferred embodiment the number of the predetermined angular positions equals three and the angular positions have substantially 120 degree spacing, although other numbers are also contemplated, for example, two angular positions and four angular positions, with 180 degree and 90 degree spacing, respectively. In some contemplated embodiments the rotator is rotated manually, while in other contemplated embodiments the rotator can be motorized and computer-controlled.

In a preferred embodiment the rotator 18 can include an angular encoding means 20 used for identifying the individual angular positions of the rotator and providing information about a current position. One example of the encoding means is an optical angular encoder having a light source and two photodiodes, such encoders being available commercially from distributors of robotic equipment. Knowledge of the order of angular positions at which panoramic images are taken is required for proper ordering of 2D point data sets measured at different angular positions and is beneficial when stitching panoramas using more than two images.

In a preferred embodiment an electronic compass 16 can be rigidly coupled to the body frame 1. The electronic compass can be advantageously used to measure orientation of the apparatus and, thus, orientation of the surveyed 2D point data sets relative to the magnetic north or then geographic north, if magnetic declination is known. Direction to the geographic north can further be advantageously shown on surveyed floor plans. In the absence of the angular encoding means 20, the electronic compass 16 can further be advantageously used to determine the order of angular positions. In the absence of the electronic compass 16, the order of the angular positions can be controlled by always rotating the rotator in a fixed direction, either always clockwise or always counterclockwise.

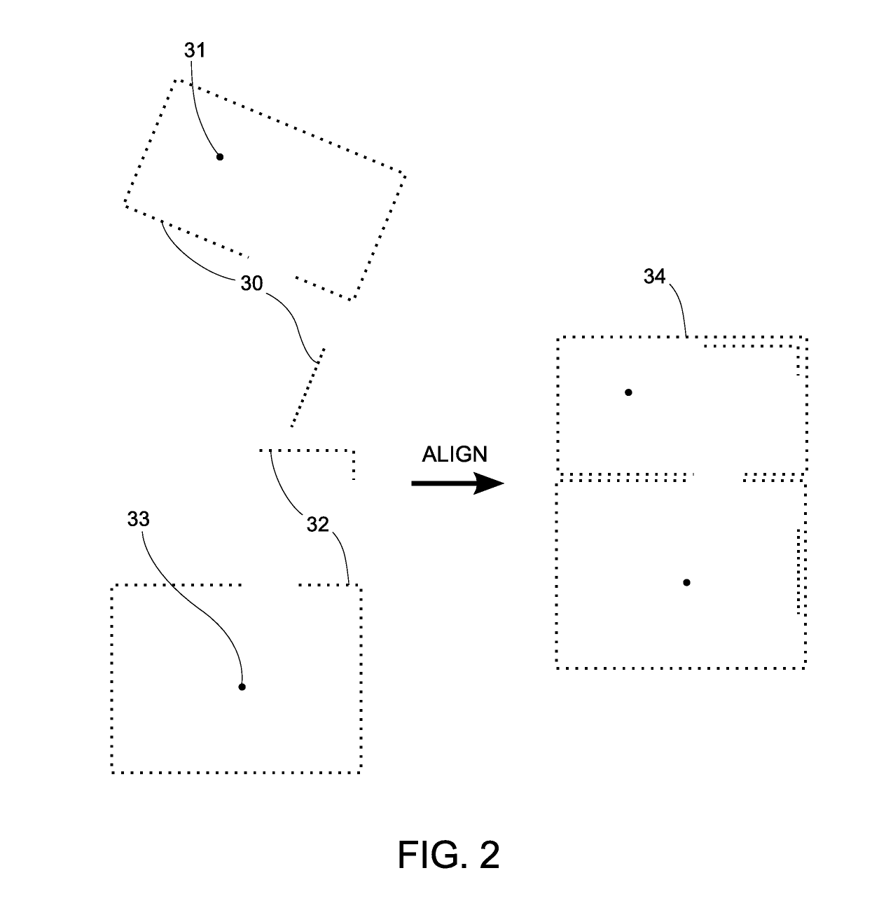

During surveying of a building, the surveying apparatus according to this disclosure is preferably placed at multiple locations or vantage points throughout the building in such a way that each measured 2D point data set has points in common with at least one other 2D point data set measured at a different location, so that the two 2D point data sets can be brought into alignment. To illustrate, FIG. 2 shows a first 2D point data set 30 that was collected from the vantage point 31 and resulted from projecting 3D intersection points onto a horizontal plane and a second 2D point data set 32 that was collected from the vantage point 33 and resulted from an analogous projection. Vantage points 31 and 32 are located in adjacent rooms connected by a door that is seen as a discontinuity in the data sets 30 and 32. Part of another room can be seen from each vantage point 31 and 32, resulting in the two data sets having points in common, those points being the points that can be seen through the door. An alignment of the data sets 31 and 32 can be performed manually or automatically to identify and bring the common points together. The result of such an alignment is a combined 2D point data set 34 consisting of 2D point data sets 30 and 32 that are brought into a common coordinate system. Repeating such an alignment step for every pair of rooms on a floor will yield a combined 2D point data set that can advantageously be used to draw a floor plan. This process of 2D point data set alignment also provides positions and orientations of the imaging system at all vantage points throughout the building. Having such information makes it easy to create virtual tours for displaying survey data on a display, wherein the imaging system positions and shooting directions are displayed on a floor plan and images can be selected for viewing by selecting their positions on the floor plan.

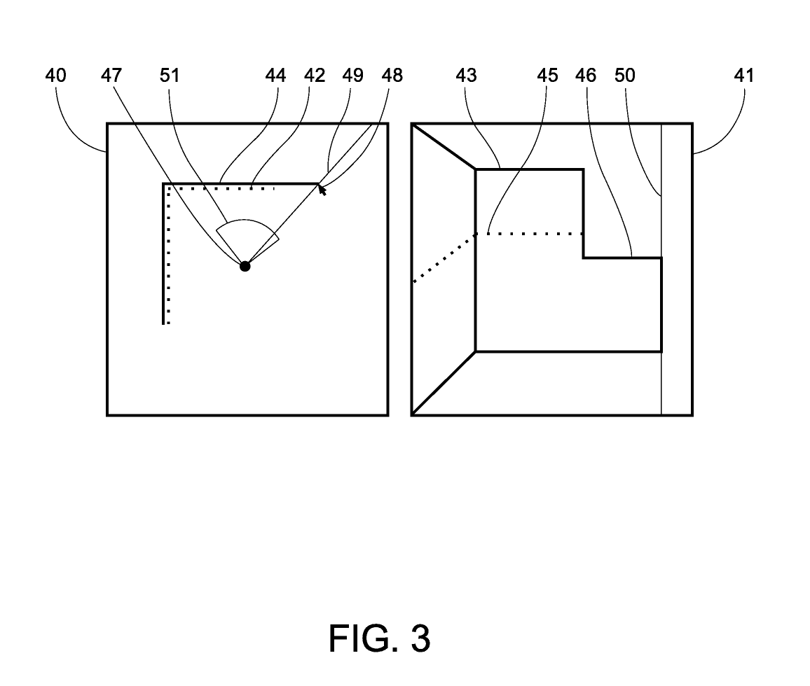

The images captured by the imaging system 6 can be used not only for photographic documenting of space, but can also aid in drawing floor plans. As shown in FIG. 1, one of the constituting subsystems of an indoor surveying apparatus according to the present invention is the computing device 15 executing an algorithm for establishing positions and extents of walls, doors, and windows and for drawing floor plans. The algorithm uses images captured by the optical imaging system 6 to fill in gaps in the 2D point data sets, more specifically, to establish extents and position of walls, doors, and windows where relevant information was not collected. FIG. 3 shows an example of user interface for an application for drawing floor plans that implements such an algorithm and the algorithm's steps are explained in the following paragraphs.

As shown in FIG. 3, projected and aligned 2D point data sets 42 are displayed in a floor plan window 40. Window 41 displays images captured by the imaging system. In the current example, an image in the window 41 shows a full height wall 43 ending with a half-height wall 46 on the right side. Center 47 in the floor plan window 40 denotes the location from which the image shown in the window 41 was captured. Orientation of the imaging system at that location was determined during the alignment process, thus it is possible to display in the window 40 the direction and extents of the field of view 51 that is visible in the image in the window 41. Dotted line 45 is the light beam emitted by the light source as it intersects with the wall 43. In the example case shown in FIG. 3, the light beam did not intersect the half-wall 46 during surveying and 2D point data set information required to determine the extents of the half-wall 46 and position of its right edge is missing. Similar difficulties can arise with windows if the light beam intersects a wall below the window or in cases when there are other objects, for example furniture, blocking line of sight from the light source to a surface of interest.

A user input device, for example a mouse, a stylus, a touchscreen, or a touchpad, is used to draw a floor plan in the window 40. The wall 43 is drawn as a line 44 in the window 40 with a user input device cursor 48 displayed at a current drawing position. Since the orientation of the imaging system at the center 47 and the field of view 51 of the image in the window 41 are known, it is possible to display in the window 40 a current viewing direction indicator 49, which corresponds to the current cursor position 48 and simultaneously display it as a vertical viewing direction indicator 50 in the window 41. Whenever the user input device changes displayed cursor position 48, the viewing direction indicator 49 rotates around center 47 and the vertical viewing direction indicator 50 slides right or left. To complete the wall 43 by drawing the half-wall 46, the line 44 is continued to the right beyond the end of the 2D point data set 42 in the window 40 until the vertical viewing direction indicator 50 coincides with the right edge of the half wall 46 in the window 41. This example demonstrates how the images can be used to fill in gaps in 2D point data sets. Doors, windows, and obstructed corners can also be measured and drawn using the described algorithm.

A surveying apparatus according to this disclosure produces surveying data consisting of correlated panoramic images and 2D point data sets. This powerful combination of such orthogonal data modalities allows efficient drawing of floor plans and enhanced presentation of surveyed space taking full advantage of the correlation between floor plans and panoramas.

Thus, specific details of an indoor surveying apparatus and methods of its use have been disclosed. It should be apparent, however, to those skilled in the art that many more modifications besides those already described are possible without departing from the inventive concepts herein. The invention, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. An indoor surveying apparatus for surveying an interior of a building, the apparatus comprising:
a light source emitting at least one divergent light beam, the at least one light beam having divergence between 1 milliradian and 20 milliradians in the vertical direction, divergence of at least 50 milliradians in a horizontal direction, wavelength ranging from 350 nanometers to 1000 nanometers, and propagating along directions that form at most 15 degree angles with a horizontal plane, whereby the at least one light beam intersects surfaces of the building's walls and other indoor objects at a plurality of 3D intersection points illuminated by the at least one light beam;
an optical imaging system for capturing color photographic images of its environment and the illuminated 3D intersection points, the imaging system coupled in the vertical relation to the light source and the imaging system comprising a color image sensor and an objective lens, the objective lens having a focal length, a distortion, an entrance pupil, and an optic axis, the optic axis forming at most 30 degree angle with a horizontal plane;
a memory storing a set of calibration coefficients for the apparatus, wherein the calibration coefficients depend on the focal length and the distortion of the objective lens, a position and an orientation of the objective lens relative to the at least one light beam, geometry of the light beam, and a position and an orientation of the image sensor relative to the objective lens; and
a computing device executing an algorithm that uses the set of calibration coefficients and locations of the 3D intersection points in the images captured by the imaging system to compute 3D coordinates of the 3D intersection points,
whereby surveying information collected by the apparatus comprises the coordinates of the 3D intersection points and the color photographic images captured from known poses relative to the 3D intersection points.

2. An apparatus according to claim 1, further comprising a computing device executing an algorithm for establishing positions and extents of walls, doors, and windows and for drawing floor plans using the 3D coordinates of the 3D intersection points and the images captured by the imaging system, wherein the images are used for establishing positions and extents of walls, doors, and windows where the 3D intersection points are missing.

3. An apparatus according to claim 1, wherein the at least one light beam has divergence between 2 milliradians and 8 milliradians in the vertical direction.

4. An apparatus according to claim 1, wherein the at least one light beam has divergence of at least 1.5 radians in a horizontal direction.

5. An apparatus according to claim 1, wherein the at least one light beam has wavelength ranging from 450 nanometers to 690 nanometers.

6. An apparatus according to claim 1, wherein the light source comprises at least one laser with line-generating optics.

7. An apparatus according to claim 1, wherein the imaging system is a consumer digital camera.

8. An apparatus according to claim 1, wherein the objective lens of the imaging system is a wide-angle lens having a field of view angle greater than the angle selected from the list consisting of 90 degrees, 120 degrees, and 180 degrees.

9. An apparatus according to claim 1, further comprising an electronic compass coupled to the imaging system, whereby the compass measures a direction of the optic axis of the objective lens.

10. An apparatus according to claim 1, further comprising a stand and a rotator, wherein the apparatus is coupled to the rotator and the rotator is coupled to the stand, the rotator having a rotation axis that is substantially vertical and passes through the entrance pupil of the objective lens, the rotator enabling the apparatus to be repeatably rotated relative to the stand through a number of predetermined substantially equally spaced throughput a full circle angular positions, wherein the number of the angular positions is selected from the list consisting of two, three, and four.

11. An apparatus according to claim 10, further comprising an encoding means for identifying the individual angular positions of the rotator and providing information about a current position.

12. A method of using the apparatus of claim 1, comprising:
turning on the light source and projecting the at least one light beam onto the building's walls and other indoor objects;
using the imaging system to capture first image of its environment and the illuminated 3D intersection points during first exposure time interval;
turning off the light source;
using the imaging system to capture second image of its environment without the illuminated 3D intersection points during second exposure time interval that is the same as the first exposure time interval;
comparing the first image and the second image to identify locations of the 3D intersection points in the first image; and
using the set of calibration coefficients and the locations of the 3D intersection points in the first image to compute 3D coordinates of the 3D intersection points,
whereby surveying information collected by the apparatus comprises the coordinates of the 3D intersection points and the color photographic images captured from known poses relative to the 3D intersection points.

13. A method according to claim 12, further comprising:
projecting the 3D intersection points onto a horizontal plane to obtain a projected 2D point data set describing the outlines of the building's walls and other indoor objects;
using the projected 2D point data set for establishing positions and extents of walls, doors, and windows and for drawing floor plans for the building; and
using the set of calibration coefficients and the images captured by the imaging system for establishing positions and extents of walls, doors, and windows and for drawing floor plans where the projected 2D points are missing.

14. A method according to claim 12, further comprising:
providing a stand and a rotator, wherein the apparatus is coupled to the rotator and the rotator is coupled to the stand;
rotating the apparatus into first angular position;
performing the steps according to claim 12 to obtain first projected 2D point data set;
rotating the apparatus into second angular position having a predetermined angular offset relative to the first angular position;
performing the steps according to claim 12 to obtain second projected 2D point data set; and
using the predetermined angular offset between the first and the second angular positions to combine the first and the second projected 2D point data sets into a combined projected 2D point data set,
whereby the combined projected 2D point data set provides greater spatial coverage than the first and the second projected 2D point data sets individually.

15. A method according to claim 14, further comprising:
placing the surveying apparatus at first location in the building;
performing steps according to claim 14 to obtain first combined projected 2D point data set;
placing the surveying apparatus at second location in the building, which has at least some surfaces of walls' and other objects' that are in common with the first location, the common surfaces being visible from both the first and the second locations;
performing steps according to claim 14 to obtain second combined projected 2D point data set; and
aligning the first and the second combined projected 2D point data sets in 2D space by aligning 2D points that belong to the common surfaces between the first and the second locations.
